(19) United States
(12) Patent Application Publication
(10) Pub. No.: US 2011/0079743 A1
(43) Pub. Date: Apr. 7, 2011

(54) ROTARY VALVE

(75) Inventor: CHI-LUNG TSAI, KAOHSIUNG CITY (TW)

(73) Assignee: SHIE YU MACHINE PARTS IND CO., LTD., TAICHUNG COUNTY (TW)

(21) Appl. No.: 12/572,894

(22) Filed: Oct. 2, 2009

(51) Int. Cl. F16K 5/08

(52) U.S. Cl. 251/314

(57) ABSTRACT

A rotary valve includes a main body provided with a valve chamber for receiving a plate valve, formed with an annular neck and bored with an intermediate hole extending downward to the valve chamber for positioning a valve rod, which is disposed in the intermediate hole when the main body is being shaped. A seal washer has its outer annular side provided with a serrated surface so that, when shaped, the main body can be combined with the serrated surface to let the seal washer covered by the inner annular wall of the valve chamber. The seal washer has an inner annular side symmetrically formed with an upper and a lower small flat surface respectively matching with an upper and a lower flat surface of the valve plate, having an upper and a lower side respectively bored with a hole for a valve rod to be inserted therein and fixed with the valve plate.

### BACKGROUND OF THE INVENTION

1. Field of the Invention

This invention relates to a rotary valve, particularly to one having a seal washer formed integrally with a main body so that the rotary valve can effectively prevent liquid from leaking, and the seal washer can be firmly fixed in position never to fall off and able to avoid being worn off.

2. Description of the Prior Art

A conventional rotary valve 1, as shown in FIGS. 1 and 2, includes a main body 10 having its upper side provided with a handle 11 that has one end fixed with the topside of a valve rod 12 by means of a nut 120. The valve rod 12 is extended downward to a valve chamber 100 of the main body 10, inserted through and combined with a valve plate 13. Thus, by turning the valve rod 12, the valve plate 13 can be opened and closed.

The valve chamber 100 of the main body 10 is provided with a seat seal 14 mostly made of EPDM (ethylene propylene diene monomer) or EPM (ethylene propylene monomer) including rubber or silica gel. The seat seal 14 is formed with an outer covering member 140 and an inner projecting edge 141, the covering member 140 covered over the outer side wall 101 of the valve chamber 100 of the main body 10, while an inner projecting edge 141 received in a recessed groove 102 in the inner side wall of the valve chamber 100, letting the seat seal 14 fixed with the annular wall of the chamber 100 of the main body 10.

The drawback of foresaid conventional seat seal 14 is that the seat seal 14 is covered over the outer annular wall of the valve chamber 100 of the main body 10 only by the outer covering member 140 and the inner projecting edge 141; therefore, long-term and repeated opening and closing of the valve plate 13 will cause friction to the seat seal 14 to make the seat seal 14 fall off the valve chamber 100, thus resulting in trouble to the rotary valve and disabling the valve plate 13 to be closed completely for preventing leakage.

### SUMMARY OF THE INVENTION

The objective of this invention is to offer a rotary valve that has a seal washer formed integrally with a main body for firmly holding the seal washer in the valve chamber of the main body to enable the seal washer to effectively prevent leakage and prolong a service life of the rotary valve.

The rotary valve in the present invention is to have the outer annular side of the seal washer combined with the main body when the main body is being shaped to let the seal washer covered by the inner annular wall of the valve chamber of the main body and fixedly positioned therein.

The seal washer of the rotary valve in the present invention is made of rubber or Teflon, having its outer annular side provided with a serrated surface, and its inner annular side symmetrically disposed with an upper and a lower small flat surface respectively matching with an upper and a lower flat surface of the plate valve for facilitating the plate valve to be rotated. The seal washer further has an upper and a lower side respectively bored with a hole for a valve rod to be inserted therein and fixed with the plate valve.

### BRIEF DESCRIPTION OF DRAWING

This invention will be better understood by referring to the accompanying drawings, wherein:

FIG. 1 is a partial front view of a conventional rotary valve;

FIG. 2 is a cross-sectional view of the line A-A in FIG. 1;

FIG. 3 is a front view of a rotary valve in the present invention;

FIG. 4 is a front view of the rotary valve after a main body is shaped in the present invention;

FIG. 5 is a cross-sectional view of the line B-B in FIG. 4;

FIG. 6 is a side view of a seal washer in the present invention; and

FIG. 7 is a cross-sectional view of the line C-C in FIG. 6.

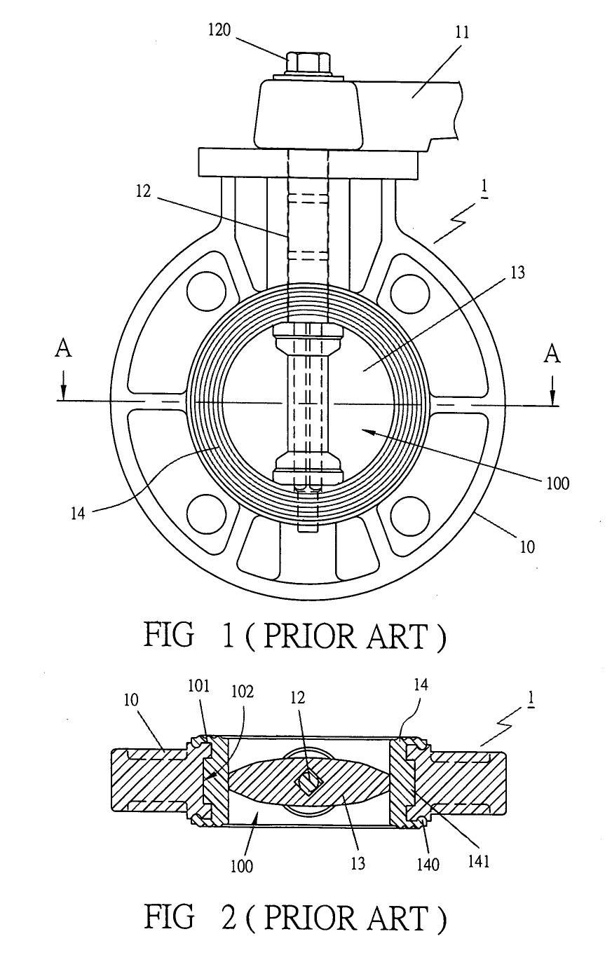

### DETAILED DESCRIPTION OF THE PREFERRED EMBODIMENT

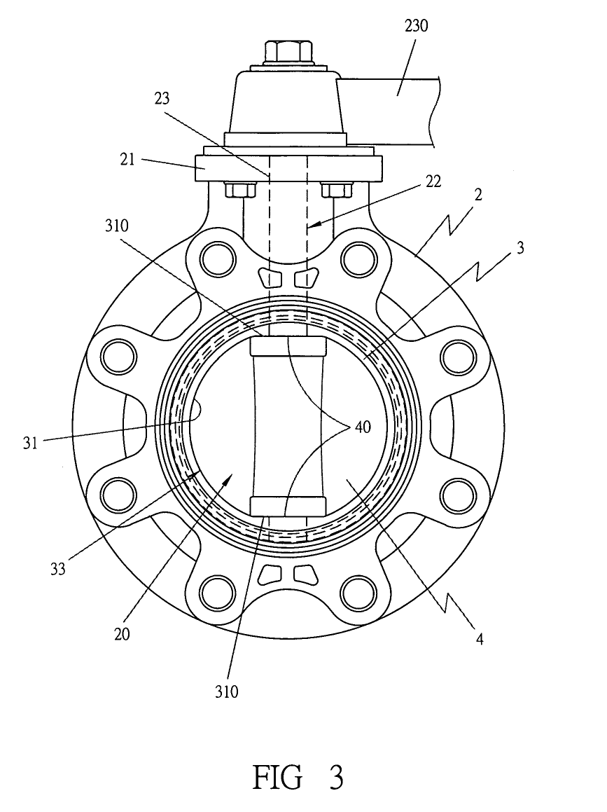

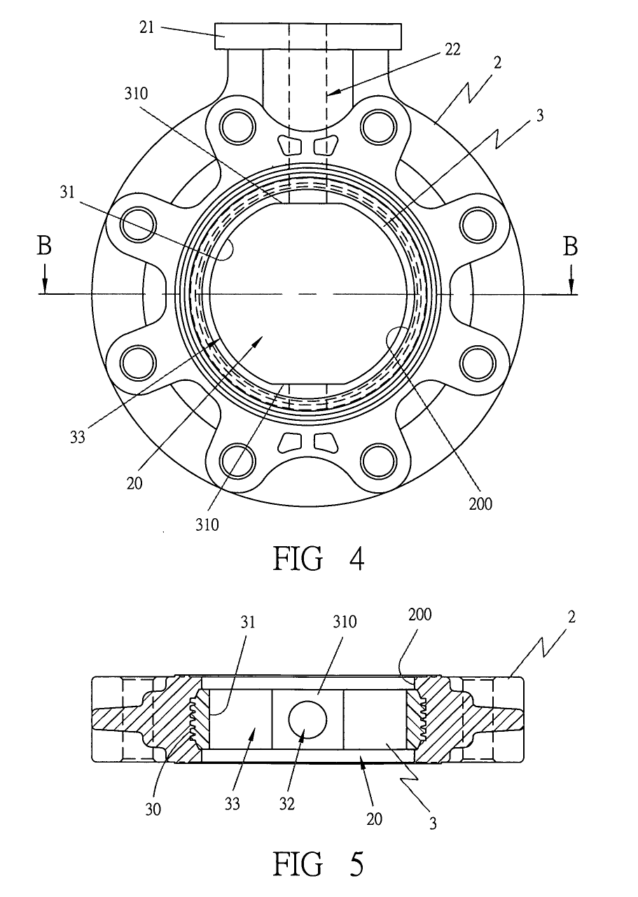

A preferred embodiment of a rotary valve in the present invention, as shown in FIGS. 3 and 4, includes a main body 2, a seal washer 3 and a plate valve 4 as main components combined together.

The main body 2 made of metal or plastic is provided with a valve chamber 20 for receiving the plate valve 4 therein and formed with an annular neck 21 for reinforcing the structure of the main body 2. The main body 2 is further bored with an intermediate hole 22 extending downward from the center of the annular neck 21 to the valve chamber 20 for receiving a valve rod 23, which is synchronously positioned in the intermediate hole 22 to be covered by the main body 2 when the main body 2 is being shaped. The valve rod 23 is combined with a handle 230 so that the valve rod 23 can be turned by the handle 230 for opening and closing the plate valve 4.

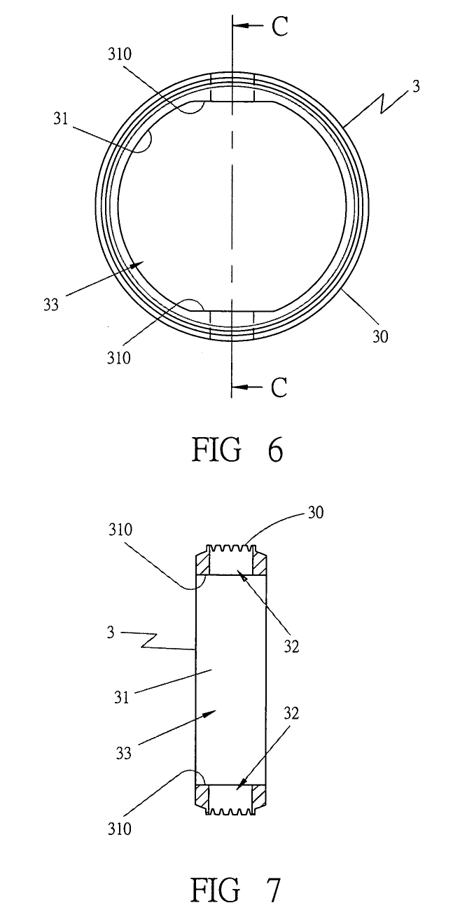

The seal washer 3, as shown in FIGS. 5-7, is made of rubber or Teflon, having its outer annular side 30 disposed with a serrated surface. Thus, when the main body 2 is shaped, the inner annular wall 200 of the valve chamber 20 can be closely combined with the outer annular side 30 of the seal washer 3, letting the seal washer 3 covered and held by the inner annular wall 200 of the valve chamber 20 of the main body 2 and firmly fixed therein never to separate from the main body 2. Further, the seal washer 3 has an inner annular side 31 symmetrically formed with an upper and a lower small flat surface 310 respectively matching with an upper and a lower flat surface 40 of the valve plate 4. By so designing, after being closed, the plate valve 4 can be completely and closely combined with the seal washer 3 for preventing liquid from leaking out and facilitating the plate valve 4 to be rotated. Furthermore, the seal washer 3 has an upper and a lower side respectively bored with a hole 32 for the valve rod 23 to be inserted therein and fixed with the valve plate 4 and its center formed with a valve port 33 for receiving the plate valve 4.

The plate valve 4 is positioned in the valve port 33 of the seal washer 3 and firmly combined with the valve rod 23.

To sum up, the rotary valve of this invention, which has the seal washer 3 formed integrally with the main body 2, can effectively prevent leakage, simplify manufacturing processes, elevate quality and service life and prevent the seal washer from falling off the main body or being worn off.

While the preferred embodiment of the invention has been described above, it will be recognized and understood that various modifications may be made therein and the appended claims are intended to cover all such modifications that may fall within the spirit and scope of the invention.

I claim:

1. A rotary valve comprising:
a main body provided with a valve chamber for receiving a plate valve, said main body bored with an intermediate hole extending downward from a center of an annular neck of said main body to said valve chamber for positioning a valve rod, said valve rod synchronously disposed in said intermediate hole when said main body is being shaped;
a seal washer having an outer annular side provided with a serrated surface, said outer annular side of said seal washer combined together with an inner annular wall of said valve chamber of said main body, said seal washer having an inner annular side symmetrically formed with an upper and a lower small flat surface respectively matching with an upper and a lower flat surface of said plate valve, said seal washer having an upper side and a lower side respectively bored with a hole for said valve rod to be inserted therein and fixed with said plate valve; and
a said valve plate received in a valve port of said seal washer and combined with said valve rod.

2. The rotary valve as claimed in claim 1, wherein said main body is made of metal or plastic.

3. The rotary valve as claimed in claim 1, wherein said seal washer is made of rubber or Teflon.
